(19) United States
(12) Patent Application Publication
(10) Pub. No.: US 2006/0061261 A1
(43) Pub. Date: Mar. 23, 2006

(54) White light emitting device

(76) Inventors: Kun-Chui Lee, Taipei City (TW); Tzu-Chi Cheng, Hsinchu County (TW); Jung-Pin Cheng, Taipei City (TW)

Correspondence Address: Kun-Chui Lee & Joint Applicants, P. O. Box No. 6-57, Junghe, Taipei, 235, TW

(21) Appl. No.: 10/945,956

(22) Filed: Sep. 22, 2004

(51) Int. Cl. H01J 1/62

(52) U.S. Cl. 313/502; 313/498

(57) ABSTRACT

A white light emitting device includes a device having at least one light emitting diode (LED) serving as a light source and being capable of emitting a light between blue and green in color; and a phosphor consisted of first and second phosphors each made of a compound from different materials. The phosphor is excited by the light from the light source to emit a first-color light and a second-color light, which are both blended with a portion of the light and altogether release to obtain a white light having enhanced color rendering effects, thereby offering the white light with illuminant contrast.

### BACKGROUND OF THE INVENTION

(a) Field of the Invention

The invention relates to a white light emitting device, and more particularly, to a white light emitting device having enhanced light rendering effects and a phosphor that is resistant to quantitative change, thereby ensuring stability and reliability of a wavelength range of the white light.

(b) Description of the Prior Art

Referring to the U.S. Pat. No. 6,351,069B1 disclosing Red-Efficiency-Compensating Phosphor LED, a phosphor thereof is consisted of two materials namely SrS:Eᵤ and YAG:Pr³⁺.

Wherein, a light emitting diode (LED) thereof is for emitting a blue light serving as a light source, which excites the phosphor in the Srs: Eᵤ material to further excite a light (first-color light) having a specific wavelength. The light source also excites the phosphor of the YAG:Pr³⁺ to further excite another light (second-color light) having a different wavelength from that of the first-color light. The two lights (the first-color and second-color lights) having different wavelengths are blended with a portion of the light source and then released, with the blended light being defined as “white light” according to naked eye.

However, the phosphor of the Srs: Eᵤ material according to the prior invention, due to chemical properties of sulfur, has unsatisfactory heat resistance, and often incurs oxidation and quantitative change caused by ambient temperature rise. The light wavelength (first-color light) released from exciting the Srs: Eᵤ material having undergone quantitative change can hardly be controlled within an expected range, and therefore it also becomes more difficult to control quality of white light having better color rendering effects in a long term.

Referring to the U.S. Pat. No. 6,504,179B1 disclosing LED-Based White-Emitting Illumination Unit, a phosphor thereof is formed by mixing green emitting phosphor that emits green lights when excited by a light source, and a yellow emitting phosphor that emits yellow lights when excited by a light source.

The LED thereof emits a blue light serving as a light source. When a portion of the light blue from of the light source is blended with the aforesaid yellow light and green light having different wavelengths, a white light is obtained. Yet, according to this prior invention, using the two distinct light having different wavelengths and excited by the blue light source of the phosphor thereof, due to lack of wavelengths ranging within the red spectrum, the white light produced has comparatively inadequate color rendering effects; that is, the white light appears rather dull.

### SUMMARY OF THE INVENTION

The primary object of the invention is to provide a white light emitting device having enhanced light rendering effects, thereby allowing the white produced with illuminant contrast.

The secondary object of the invention is to provide a white light emitting device having a phosphor thereof being resistant from quantitative change by being a heat-resistant and stable material, thereby ensuring high quality and enhanced coloring rendering effects of the white light produced in a long term.

### BRIEF DESCRIPTION OF THE DRAWINGS

FIG. 1 shows a flow chart of the method according to the invention.

FIG. 2 shows a curve diagram illustrating a spectrum of a first-color light emitted from a second phosphor excited by a light source.

FIG. 3 shows a curve diagram illustrating a spectrum of a second-color light emitted from a first phosphor excited by a light source.

FIG. 4 shows a curve diagram illustrating a spectrum of a white light according to the invention.

FIG. 5 shows a sectional view of the device in an embodiment according to the invention.

### DETAILED DESCRIPTION OF THE PREFERRED EMBODIMENTS

To accomplish the aforesaid objects, descriptions of the invention shall be given with the accompanying drawings below.

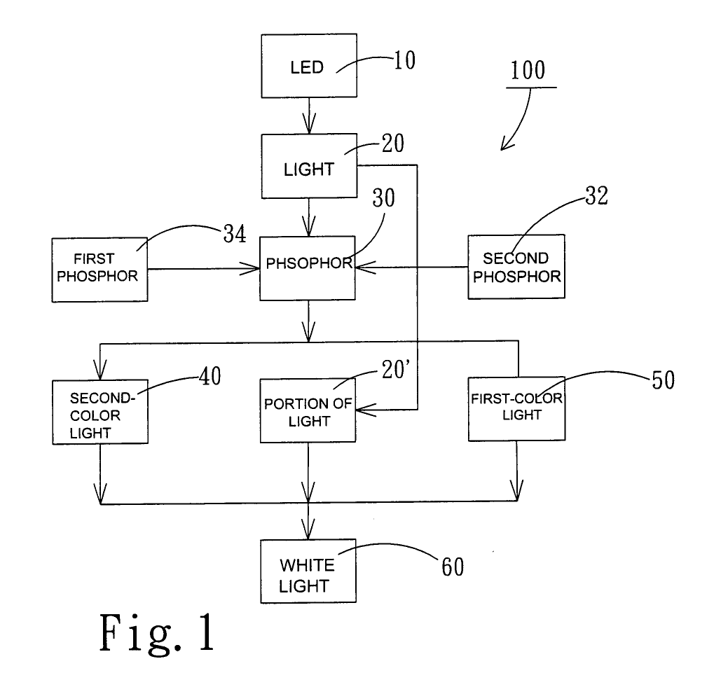

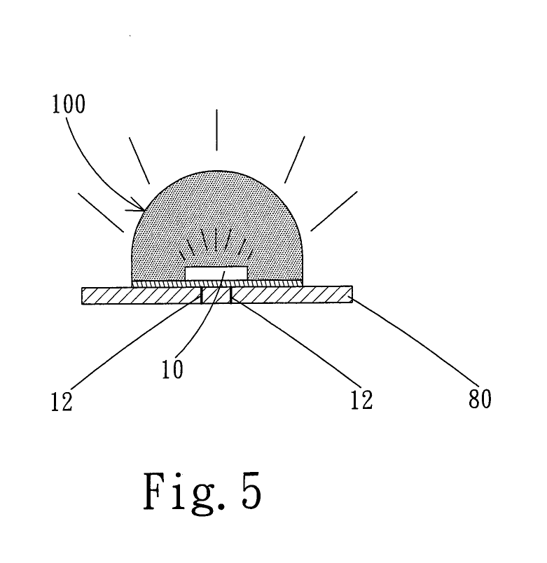

Referring to FIGS. 1 and 5, a white light emitting device according to the invention comprises characteristics of:
a device 100 having at least one light emitting diode (LED) 10 for serving as a light source and being capable of emitting a light 20 located between blue and green spectra;
a phosphor 30 capable of effectively absorbing the light 20 and being further excited to emit a second-color light 40 and a first-color light 50, wherein the first-color and second-color lights 50 and 40 are blended with a light 20′ from a portion of the light source to obtain a white light 60 having good light rendering effects; and consisted of a second phosphor 32 and a first phosphor 34, wherein the second phosphor 32 is selected from one or several of the following compounds:
(a) YAG:Cₑ with Cₑ as an activator thereof;
(b) TbAG: Cₑ with Cₑ as an activator thereof;
   and the first phosphor 34 is selected from one or several of the following compounds:
(a) Gd₃Al₅O₁₂ with Cₑ as an activator thereof;
(b) YAG: Eᵤ with Eᵤ as an activator thereof;
(c) Y₂O₃: Eᵤ, Bi with a compound of Eᵤ and Bi as an activator thereof;
(d) Y(Gd)BO₃: Eᵤ with Eᵤ as an activator thereof;
(e) 6MgO.A_{S2}O₅:Mₙ with Mₙ as an activator thereof;
(f) 4MgOF₂GeO₂: Mₙ with Mₙ as an activator thereof; and
(g) GdMgB₅O₁₀ with a compound at least consisting Cₑ, T_{b}, Mₙ or Eᵤ as an activator thereof.

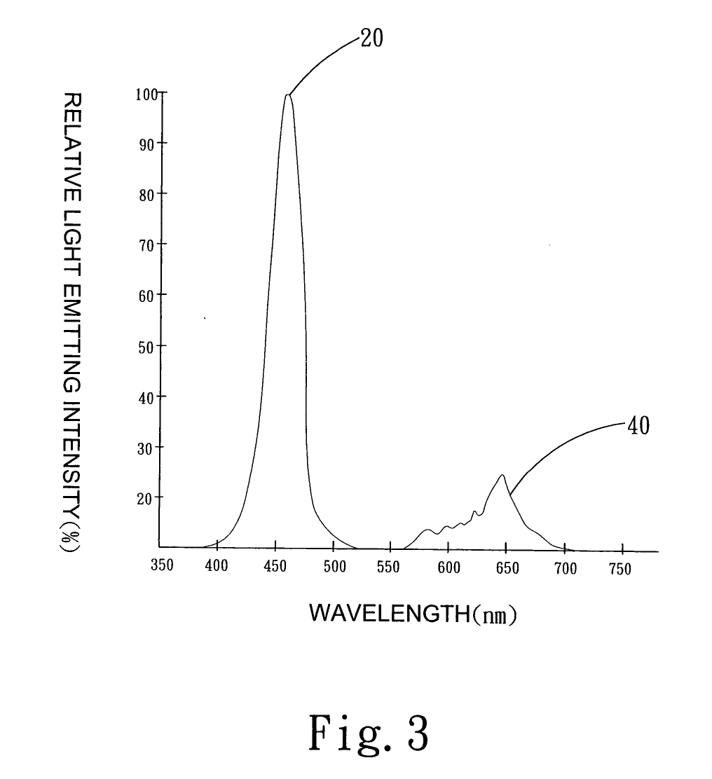

According to the aforesaid primary characteristics, a wavelength of the second-color light 40 is preferably selected from a range between 580 to 700 nm, and a wavelength of the first-color light is preferably selected from a range between 520 to 565 nm and has a color tone defined within a green spectrum. The second-color light is produced from the first phosphor 34 excited by the light 20 of the light source, and has a color tone defined within the red spectrum. The first-color light 50 is produced from the second phosphor 32 excited by the light 20 of the light source as shown in FIG. 3.

According to the aforesaid primary characteristics, wavelengths emitted by the LED 20 are selected from a range between 360 and 560 nm.

According to the aforesaid primary characteristics, the phosphor 30 is mounted on or located approaching the LED 10, thereby effectively absorbing the light 20 of the light source.

According to the aforesaid primary characteristics, the LED 10 has a conductive connecting end 12 thereof connected to a circuit board 80.

According to the aforesaid primary characteristics, when the second phosphor 32 is made of YAG, an activator thereof may be either be an individual element or a compound from Pr and Dy. When the second phosphor 32 is made of TbAG, an activator thereof may either be an individual element or a compound from Pr and Dy.

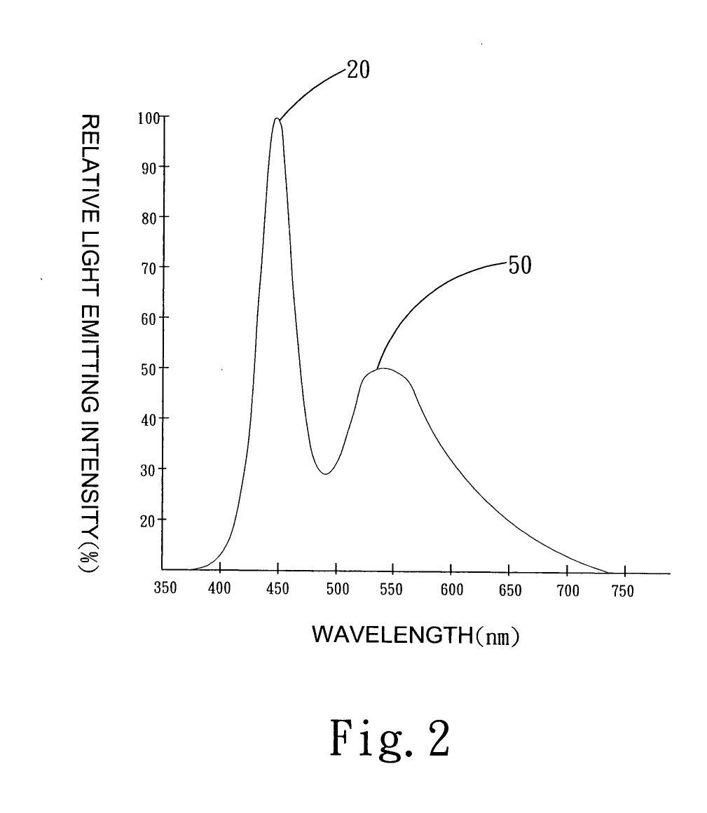

Referring to FIGS. 1 and 5 again, the device 100 according to the invention comprises an LED 10 serving as a light source. The LED 10 has two conductive connecting ends 12 thereof connected to a circuit board 80 to form an electric loop. When the circuit is conducted, the LED 10 emits a light 20 having a wavelength ranging between 360 and 560 nm, wherein a color of the light 20 is defined between blue and green spectra. In this embodiment according to the invention, the light 20 having a peak wavelength preferably between 400 and 450 nm is selected as shown in FIGS. 2 and 3. The phosphor 30 is consisted of the first and second phosphors 34 and 32, and is mounted on, covered by or located approaching the LED 10. The second phosphor 32 may be selected from one or more of the following compounds:
(a) YAG: Cₑ with Cₑ as an activator thereof; and
(b) TbAG: Cₑ with Cₑ or T_{b} as an activator thereof.

Therefore, when the phosphor 30 containing a material from the second phosphor 32 is illuminated and excited by the light 20 of the light source, a first-color light 50 having a wavelength ranging between 520 and 565 nm is emitted by the phosphor 30, wherein the first-color light 50 is defined as a wavelength range within the green spectrum. When the second phosphor 32 is made of YAG, an activator thereof can either be an individual element from Pr and Dy, or a compound of the two activators. When the second phosphor 32 is made of TbAG, an activator thereof may either be individual element selected from Dy or Pr, or a compound of the two activators.

The first phosphor 34 may be an individual element or a compound of at least two elements from the following:
(a) Gd₃Al₅O₁₂: Cₑ with Cₑ as an activator thereof;
(b) YAG: Eᵤ with Eᵤ as an activator thereof;
(c) Y₂O₃: Eᵤ, Bi with a compound of Eᵤ and Bi as an activator thereof;
(d) Y(Gd)BO₃: Eᵤ with Eᵤ as an activator thereof;
(e) 6MgO. A_{S2}O₅: Mₙ with Mₙ as an activator thereof;
(f) 4MgOF₂GeO₂: Mₙ with Mₙ as an activator thereof; and
(g) GdMgB₅O₁₀ with a compound at least consisting Cₑ, T_{b}, Mₙ, or Eᵤ as an activator thereof.

When illuminated and excited by the light 20 of the light source, the second phosphor 32 emits a first-color light 50 having a wavelength ranging between 520 and 565 nm as shown in FIG. 2. The first-color light 50 is defined as having a wavelength range within a green spectrum.

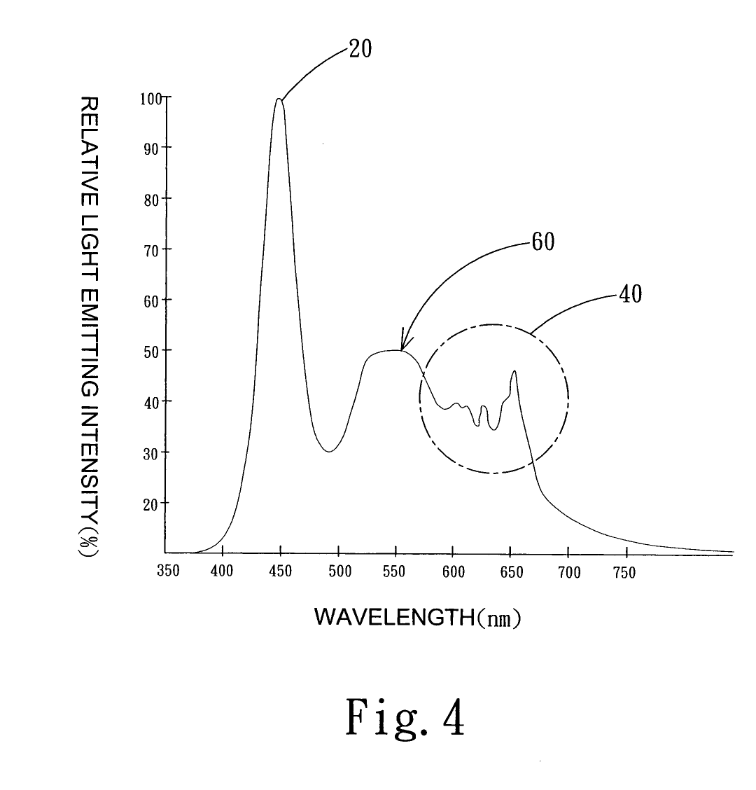

A portion light 20′ from the light 20 of the light source having not excited the first and second phosphors 34 and 32, is blended with the first-color and second-color lights 50 and 40, and altogether released out of the device 100 to obtain a white light 60 having good color rendering effects. Referring to FIG. 4 showing a curve diagram illustrating a white light spectrum obtained by experiments according to the invention, the spectrum is a curve diagram of the three wavelengths from the first-color and the second-color lights 50 and 40, and the portion light 20′. In the diagram, a curve of the second-color light 40 in a marked area appears rather distinct, so as to enhance rendering effects of the white light 60 blended by the three different wavelengths.

Using the invention, a white light obtained approaches natural sunlight (white light) and is therefore regarded as having an excellent white light tone.

In addition, the first and second phosphors 34 and 32 according to the invention are free from sulfur, and are thus provided with higher heat-resistance for preventing the first and second phosphors from quantitative change caused by ambient temperature change.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A white light emitting device comprising characteristics of:
a device having at least one light emitting diode (LED) serving as a light source for emitting a light between blue and green spectra;
a phosphor capable of effectively absorbing the light from the light source to further excite and produce a second-color light and a first-color light, wherein the first-color and second-color lights are blended with a portion of the light from the light source, and then altogether released to obtain a white light having good color rendering effects; and consisted of a first phosphor and a second phosphor, wherein the second phosphor is selected from one or more than one of the following compounds:
a. YAG: Cₑ with Cₑ as an activator thereof;
b. TbAG: Cₑ with Cₑ or T_{b} as an activator thereof; and
the first phosphor is selected from one or more than one of the following compounds:
a. Gd₃Al₅O₁₂: Cₑ with Cₑ as an activator thereof;
b. YAG: Eᵤ with Eᵤ as an activator thereof;
c. Y₂O₃: Eᵤ, Bᵢ with a compound of Eᵤ and Bᵢ as an activator thereof;
d. Y(Gd)BO₃: Eᵤ with Eᵤ as an activator thereof);
e. 6MgO. A_{S2}O₅: Mₙ with Mₙ as an activator thereof;
f. 4MgOF₂GeO₂: Mₙ with Mₙ as an activator thereof; and
g. GdMgB₅O₁₀ with a compound at least consisting Cₑ, T_{b}, Mₙ or Eᵤ as an activator thereof.

2. The white light emitting device in accordance with claim 1, wherein a wavelength of the second-color light ranges between 580 and 700 nm, a wavelength of the first-color light ranges between 520 and 565 nm and is defined as within a green spectrum, and the second-color light is produced from the first phosphor excited by the light from the light source and is defined as within a red spectrum; and the first-color light is produced by the second phosphor excited by the light from the light source.

3. The white light emitting device in accordance with claim 1, wherein a wavelength of the light emitted by LED is selected from a range between 360 and 560 nm.

4. The white light emitting device in accordance with claim 1, wherein the phosphor is mounted on or located approaching the LED, thereby effectively absorbing the light from the light source.

5. The white light emitting device in accordance with claim 1, wherein the LED has a conductive connecting end thereof connected to a circuit board.

6. The white light emitting device in accordance with claim 1, wherein when the second phosphor is made of YAG, an activator thereof may be an individual element or a compound of Pr and Dy; and when the second phosphor is made of TbAG, an activator thereof may be an individual element or a compound of Pr and Dy.
